(19) United States
(12) Patent Application Publication
(10) Pub. No.: US 2008/0106059 A1
(43) Pub. Date: May 8, 2008

(54) Method and apparatus for a light-weight transport wheelchair

(75) Inventors: David P. Jacobs, Highland Park, IL (US); Ishwor P. Adhikari, Mundelein, IL (US); Richard P. Derks, Hawthorn Woods, IL (US)

Correspondence Address: NIXON PEABODY LLP, 161 N. CLARK STREET, 48TH FLOOR, CHICAGO, IL, 60601-3213, US

(73) Assignee: Medline Industries, Inc.

(21) Appl. No.: 11/594,676

(22) Filed: Nov. 8, 2006

(51) Int. Cl. B62M 1/14

(52) U.S. Cl. 280/250.1

(57) ABSTRACT

A manual transport wheelchair for transporting a person is changeable between a transport position and a folded position. The wheelchair has two side frames coupled by a single scissor frame that is movable to change the wheelchair between the transport position and the folded position. The wheelchair has a weight capacity-to-weight ratio of at least nineteen.

### FIELD OF THE INVENTION

The present invention relates generally to manual transport wheelchairs. More particularly, the present invention relates to a folding wheelchair of light-weight and high weight capacity.

### BACKGROUND OF THE INVENTION

Numerous health patients require wheelchair assistance when walking, especially over long distances, but also desire an active lifestyle. One type of wheelchair that is commonly used is a transport wheelchair (referred to hereinafter interchangeably as the “wheelchair” or the “transport wheelchair”), which is also known as a “companion chair” because it generally has smaller wheels and requires a person to push the wheelchair from behind. The wheelchair must be sufficiently strong to safely support the weight of a wheelchair user and, yet, it must be light enough to allow easy transportation. For example, an elderly person may require the use of the wheelchair when engaging in activities outside of the home, e.g., going to a mall, visiting a park, eating dinner at a restaurant, etc. To be able to engage in the desired activities, it is necessary to transport the wheelchair to the location of the desired activities, e.g., loading and unloading the wheelchair to and from the trunk of a car. In many cases, the person transporting the chair is the spouse of the wheelchair user. The spouse may be an elderly person that may have difficulty lifting a heavy wheelchair. In other cases, even if the person transporting the chair may be an employed caretaker handling the wheelchair may still be cumbersome.

Although attempts have been made to provide light-weight transport wheelchairs, these wheelchairs have numerous problems. One problem associated with some current wheelchairs is that they generally weigh over nineteen pounds. Thus, these so called “light-weight” wheelchairs may be deemed as being “too heavy” by a person of advanced age. Any reduction in weight, e.g., even a few ounces, may be deemed of considerable value to the wheelchair users and transporters because the wheelchair can be more portable than current wheelchairs.

Another problem associated with some current wheelchairs is that the wheelchairs may become unstable. An improper reduction of weight, such as eliminating one or more structural member, may lead to an unstable wheelchair that may malfunction under particular conditions. For example, while the unstable wheelchair may function adequately on a flat and generally horizontal surface, the unstable wheelchair may tip over when traversing an inclined surface. Thus, weight reduction requires more than simply eliminating parts or using smaller structural members.

Yet another problem associated with current transport wheelchairs is that they have a generally low weight capacity. For example, some of these wheelchairs have a maximum weight capacity of only about 225 pounds. Thus, these wheelchairs fail to provide adequate support and stability for individuals having a weight that exceeds the maximum weight capacity. These wheelchairs also fail to adequately support individuals of a smaller weight than the maximum weight capacity if these individuals transport additional items, such as grocery bags, resulting in a combined weight that is greater than the maximum weight capacity.

Therefore, there exists a need for a transport wheelchair that is stable, that has a low weight, and that has a high weight capacity in comparison to current transport wheelchairs, while maintaining the look and feel of a true wheelchair.

### SUMMARY OF THE INVENTION

According to one embodiment, a manual transport wheelchair for transporting a person is changeable between a transport position and a folded position. The wheelchair has two side frames coupled by a single scissor frame that is movable to change the wheelchair between the transport position and the folded position. The wheelchair has a weight capacity-to-weight ratio of at least nineteen.

According to another embodiment, a method of manufacturing a manual transport wheelchair includes coupling a first side frame to a second side frame via a single scissor frame, the scissor frame being movable to change the wheelchair between a transport position and a folded position. A seating area is attached to the scissor frame, the seating area having a weight capacity of at least three hundred pounds and the wheelchair having a weight of less than sixteen pounds. The seating area is supported on a plurality of support tabs when the wheelchair is in the transport position.

According to a further embodiment, a wheelchair is movable between a transport position for transporting a person and a folded position for storing the wheelchair. The wheelchair includes a seating area, a pair of side frames, a plurality of support tabs, and a single centrally located scissor frame. The seating area supports the person in the seated position. The pair of side frames has respective front members and rear members, the front members being respectively coupled to the rear members via longitudinal upper members and longitudinal lower members. The plurality of support tabs is attached to the longitudinal upper members for supporting the seating area when the wheelchair is in the seated position. The scissor frame couples the pair of side frames to each other and is movable to change the wheelchair between the seated position and the folded position. The wheelchair has a maximum weight of less than sixteen pounds and a weight capacity-to-weight ratio of at least nineteen.

The above summary of the present invention is not intended to represent each embodiment or every aspect of the present invention. The detailed description and Figures will describe many of the embodiments and aspects of the present invention.

### BRIEF DESCRIPTION OF THE DRAWINGS

The foregoing and other advantages of the invention will become apparent upon reading the following detailed description and upon reference to the drawings.

FIG. 1 illustrates a perspective view of a manual transport wheelchair, according to one embodiment.

FIG. 2 illustrates an exploded view of the wheelchair.

FIG. 3A illustrates a top view of a seating region of the wheelchair.

FIG. 3B illustrates a front view of the seating region.

FIG. 3C illustrates a side view of the seating region.

FIG. 4 illustrates a front view of a back support area of the wheelchair shown in a lowered position.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention.

### DESCRIPTION OF ILLUSTRATIVE EMBODIMENTS

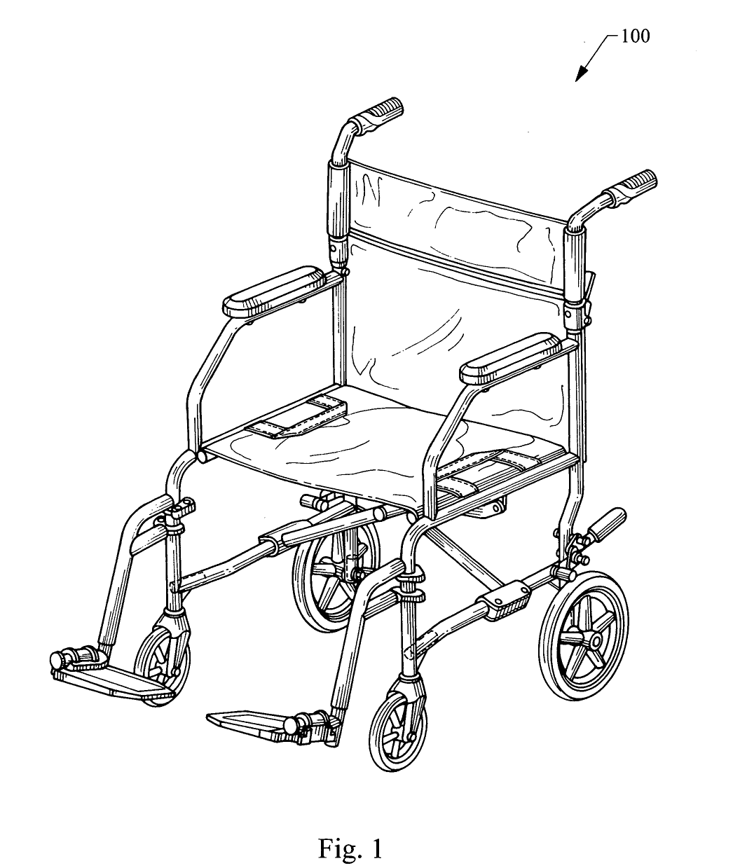

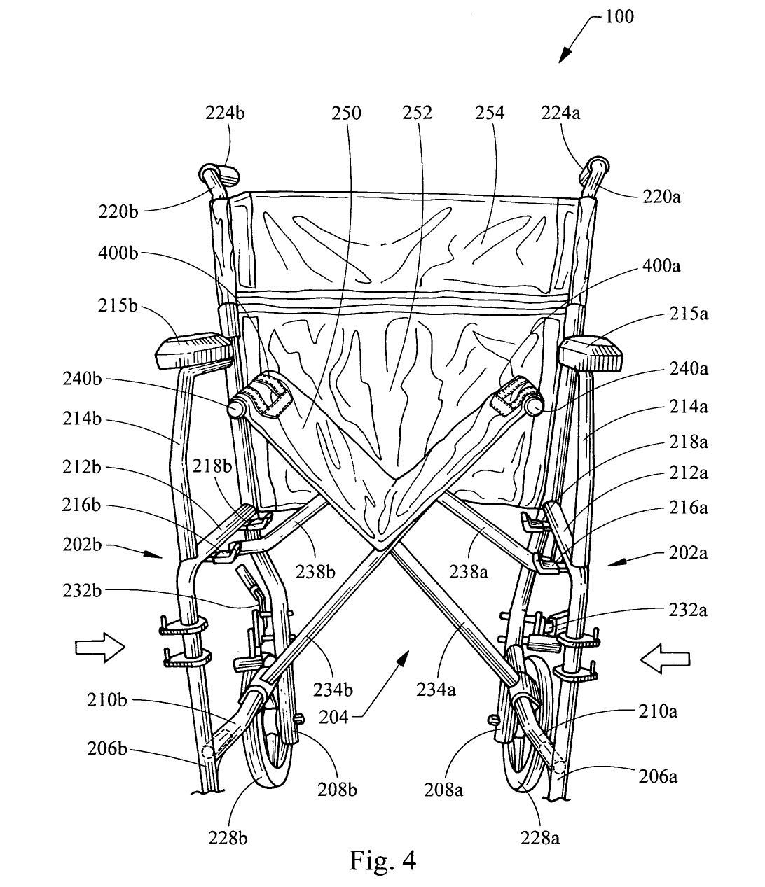

Referring to FIG. 1, a manual transport wheelchair 100 is shown in a transport position for transporting a person. The wheelchair 100 is changeable between the transport position and a folded position, which is generally used when storing the wheelchair 100 (see FIG. 4). The wheelchair 100 is a light-weight transport wheelchair that weighs less than about 16 pounds and that has a weight capacity of at least 300 pounds. For example, according to one embodiment the weight of the wheelchair 100 is 15.6 pounds. In contrast to current wheelchairs, the weight capacity-to-weight ratio of at least 19 (with a weight of 15.6 pounds) of the wheelchair 100 allows easier portability and higher weight capacity. Thus, wheelchair users are likely to prefer using the wheelchair 100 based at least on its low weight, or on its high weight capacity-to-weight ratio.

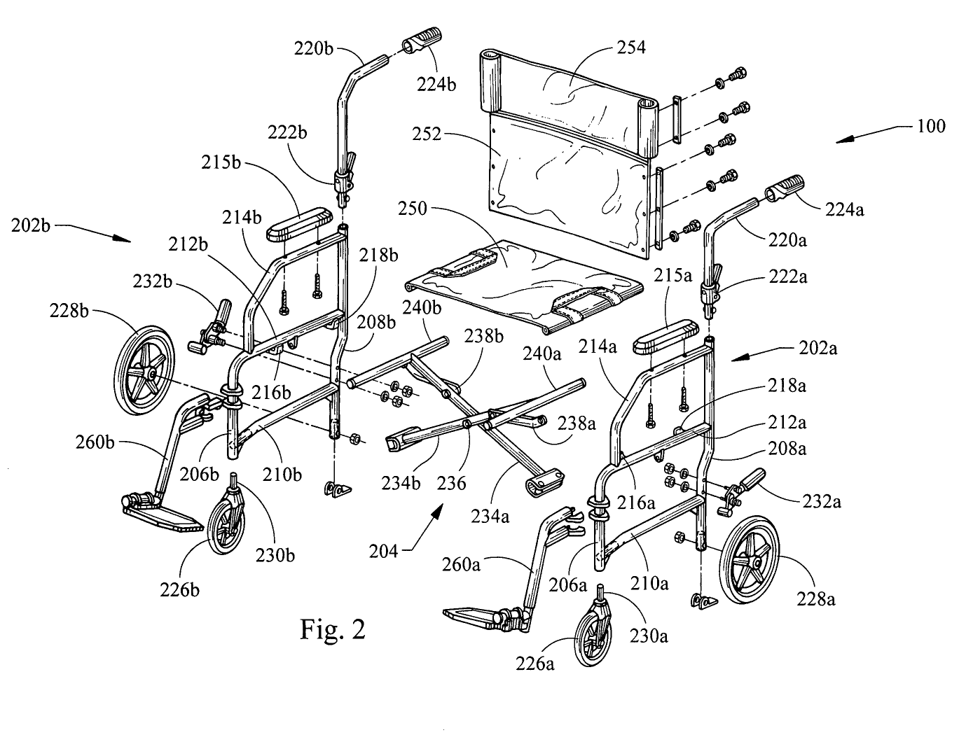

Referring to FIG. 2, the wheelchair 100 includes a pair of side frames 202a, 202b that are coupled to each other via a single scissor frame 204. Because the wheelchair 100 is generally symmetrical along a central plane of the scissor frame 204, the side frames 202a, 202b are generally identical and, therefore, a detailed explanation will be provided referring only to one of the side frames (i.e., the left side frame 202a). However, in alternative embodiments (not shown) the side frames 202a, 202b are not generally identical.

The side frame 202a includes a front member 206a and a rear member 208a that are coupled via a lower longitudinal member 210a and an upper longitudinal member 212a. The front member 206a has a lower end that extends beyond an intersection between the front member 206a and the lower longitudinal member 210a. The rear member 208a has a lower end that extends beyond an intersection between the rear member 208a and the lower longitudinal member 210a. The lower end of the rear member 208a is closer to a horizontal floor plane than the lower end of the front member 206a.

The upper longitudinal member 212a is generally angled rearwardly such that a front end (which is coupled to the front member 206a) is higher than a rear end (which is coupled to the rear member 208a) relative to the horizontal floor plane. Having the upper longitudinal member 212a angled with respect to the horizontal floor plane minimizes the likelihood that the user will slip or fall from the wheelchair 100.

The left side frame 202a further includes an armrest member 214a having a horizontal end coupled to the rear member 208a and a vertical end coupled to the upper longitudinal member 212a, the horizontal end and the vertical end being connected via a slanted member. The slanted member has a front end that is located lower (or closer to the upper longitudinal member 212a) than a rear end. The slanted member forms one continuous member with the horizontal end and the vertical end of the armrest member 214a (e.g., it does not require welding) to minimize the weight of the armrest member 214a, while maintaining a high structural strength. Alternatively, the slanted member is a separate member from the horizontal end and the vertical end of the armrest member 214a (e.g., it requires welding). The slanted member of the armrest member 214a can be used by a wheelchair user to support himself or herself when changing between a seated position and a standing position. An armrest pad 215a is coupled to the armrest member 214a for comfort of the user.

The left side frame 202a also includes a pair of supporting tabs, having a front supporting tab 216a and a rear supporting tab 218a. The front supporting tab 216a is located near the front member 206a and the rear supporting tab 218a is located near the rear member 208a. The supporting tabs 216a, 218a have a general “C” shape and are made from aluminum or aluminum alloys. Further, the supporting tabs 216a, 218a include an outer non-metallic sleeve (e.g., polyurethane). Because the upper longitudinal member 212a is angled rearwardly, the front supporting tab 216a is higher relative to the horizontal floor plane than the rear supporting tab 218a. In alternative embodiments, the number, shape, or material of the supporting tabs 216a, 216b, 218a, 218b may vary based on particular design requirements.

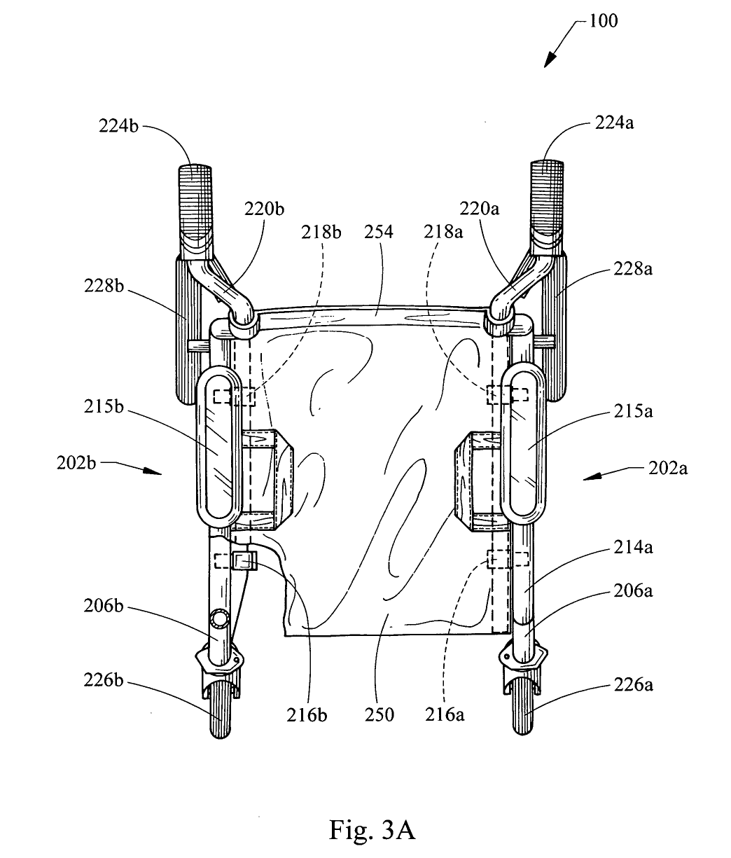

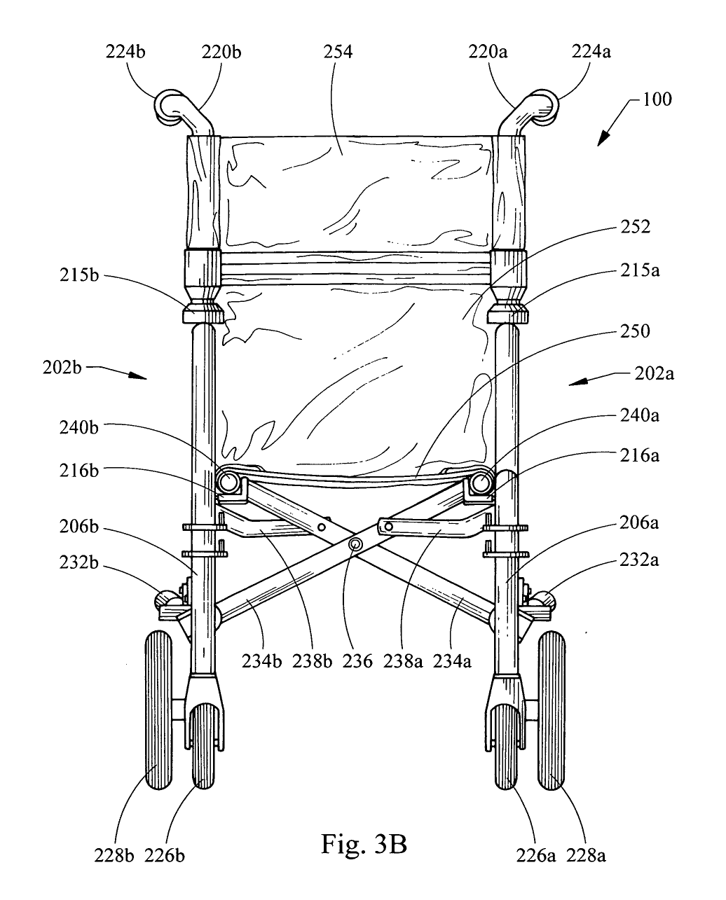

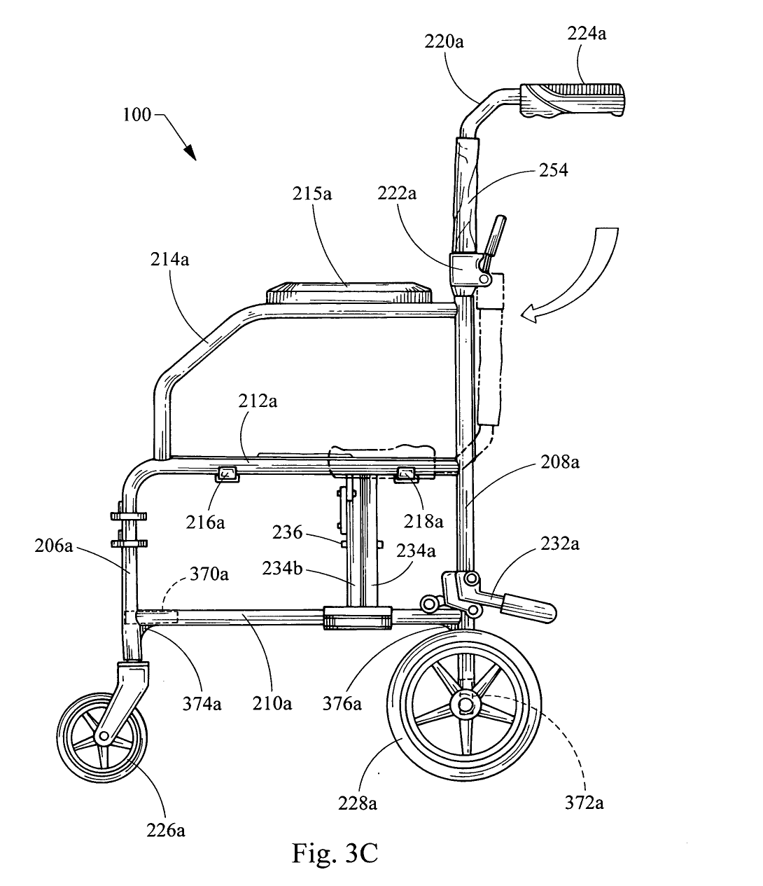

A cane tube 220a is coupled to the rear member 208a via a latching mechanism 222a at an upper end of the rear member 208a. The cane tube 220a includes an upper end that is flared outwards, relative to the interior of the wheelchair 100, and that includes a push grip 224a. The latching mechanism 222a permits the cane tube 220a to rotate from an upright position (as shown) to a bent downward position (shown in FIG. 3C) for achieving a compact storage position of the wheelchair.

A front caster 226a and a rear wheel 228a are attached respectively to the lower ends of the front member 206a and the rear member 208a. The front caster 226a is attached to the front member 206a by inserting a caster shaft 230a into the lower end of the front member 206a. Alternatively, the front caster 226a can be attached to the wheelchair 100 using various fasteners. The rear wheel 228a is attached to the rear member 208a via a central region of the wheel. The rear wheel 228a can have an outer diameter such that the outer periphery of the rear wheel 228a is lower than the intersection of the rear member 208a and the lower longitudinal member 210a.

A brake mechanism 232a is mounted on the rear member 208a near and above the outer periphery of the rear wheel 228a. The brake mechanism 232a is used by a person transporting the wheelchair 100 to securely fix the rear wheel 228a while in a stopped position.

The scissor frame 204a includes a pair of cross-members 234a, 234b that are pivotably connected to each other at a central pivoting point 236. The lower ends of the cross-members 234a, 234b are pivotably attached respectively to the lower longitudinal members 210a, 210b. A couple of pivoting arms 238a, 238b are attached respectively, at one end, to the cross-members 234a, 234b and, at another end, to the upper longitudinal members 212a, 212b. The pivoting arms 238a, 238b are pivotable at both ends.

The scissor frame 204 further includes a pair of seat supports 240a, 240b that are securely attached to a respective upper end of the cross-members 234a, 234b. When the wheelchair 100 is in the transporting position (e.g., the user is seated in the chair), the seat supports 240a, 240b are supported by the four supporting tabs 216a, 216b, 218a, 218b.

The wheelchair 100 includes a seating area 250, which is attached at each end to a respective one of the seat supports 240a, 240b, a lower back area 252, which is attached to the rear members 208a, 208b, and an upper back area 254, which is attached to the cane tubes 220a, 220b. The seating area 250, the lower back area 252, and the upper back area 254 are made from a flexible material, such as any upholstery material. For example, the material can be a vinyl material.

A pair of optional leg riggings 260a, 260b for supporting the user's legs are attachable respectively to the front members 206a, 206b. The leg riggings 260a, 260b are removable, height adjustable, and pivotable. The weight of the leg riggings 260a, 260b, which is about 1.4 pounds per leg rigging, is not included in the weight of the chair, which, as mentioned above is under 16 pounds, and, in some embodiments, at most 15.6 pounds.

Referring to FIG. 3A, a top view of the wheelchair 100 shows a cutout to expose the location of the front support tab 216b of the right side frame 202b. The remaining support tabs 216a, 218a, 218b are shown as hidden components (with dashed lines). The outward flare of the cane tubes 220a, 220b is clearly displayed as the cane tubes 220a, 220b have a generally 45° angle with a horizontal line aligned with the upper back area 254. The lower longitudinal members 210a, 210b are generally parallel and slightly offset inward relative to the upper longitudinal members 212a, 212b.

Referring to FIG. 3B, a front view of the wheelchair 100 shows the seat supports 240a, 240b resting on the front support tabs 216a, 216b and the rear support tabs 218a, 218b (not shown) when the wheelchair 100 is in the transporting position. The brake mechanisms 232a, 232b are not applied and, thus, the wheelchair 100 is freely movable to transport the user.

Referring to FIG. 3C, a side view of the wheelchair 100 represents the pivoting motion of the cane tubes 220a, 220b, which causes the cane tubes 220a, 220b and the upper back area 254 to swing downward for minimizing the space required to store the wheelchair 100. The latching mechanisms 222a, 222b are unlatched to release the cane tubes 220a, 220b from their respective upright positions. After being unlatched, the cane tubes 220a, 220b are pivoted downwards (as shown by the arrow) to a position in which the cane tubes 220a, 220b are generally parallel to the rear members 208a, 208b such that the push grips 224a, 224b are overlapping next to the upper longitudinal members 212a, 212b. According to an embodiment of the present invention, the latching mechanisms 222a, 22b are located approximately half the distance between the seating area 250 and the top edge of the upper back area 254.

The wheelchair 100 has a plurality of structural reinforcements, including a front reinforcement tubing 370a, a rear reinforcement tubing 372a, a front reinforcement weld 374a, and a rear reinforcement weld 376a. The front reinforcement tubing 370a is located within a front portion of the lower longitudinal member 210a and the rear reinforcement tubing 372a is located within the rear member 208a, near the rear wheel 228a attachment point. The front reinforcement weld 374a is located below the front end of the lower longitudinal member 210a, at the intersection with the front member 206a. The rear reinforcement weld 376a is located below the rear end of the lower longitudinal member 210a, at the intersection with the rear member 208a. The structural reinforcements provide structural support for the light-weight wheelchair 100 for maintaining a high weight capacity.

The tubular members of the wheelchair 100 (e.g., the front members 206a, 20b, the rear members 208a, 208b, the lower longitudinal members 210a, 210b,the upper longitudinal members 212a, 212b, the cross-members 234a, 234b, etc.) are optionally made using aluminum tubing having a diameter thickness of 2 millimeters (0.08 inches) or less. For example, according to one embodiment, the lower longitudinal member 210a has a length of 448 millimeters (17.64 inches), a diameter of 10 millimeters (0.39 inches), a diameter thickness of 2 millimeters (0.08 inches), and is made using aluminum 6061T4. Similarly, according to an alternative embodiment, the rear member 208a (from its lower end to the central axis of the upper longitudinal member 212a) has a length of 335 millimeters (13.19 inches), a diameter of 12 millimeters (0.47 inches), a diameter thickness of 2 millimeters (0.08 inches), and is made using aluminum 6061T4. The portion of the rear member 208a from its lower end to the central axis of the lower longitudinal member 210b (i.e., the intersection between the rear member 208a and the lower longitudinal member 210b) is 127 millimeters (5.00 inches), according to yet another alternative embodiment. According to one embodiment of the present invention, the wheelchair 100 has an overall height dimension of 876.3 millimeters (34.5 inches) and an overall front-to-back length of 723.9 millimeters (28.5 inches).

Optionally, all the structural members of the wheelchair 100 (e.g., all the members of the side frames 202a, 202b) are made using aluminum or aluminum alloys. In alternative embodiments, other light-weight materials may be used.

Referring to FIG. 4, the wheelchair 100 is displayed in a partially folded position having the side frames 202a, 202b closer to each other than in the transporting position shown in FIGS. 1-3C. The arrows show the direction of movement as the side frames 202a, 202b are moved inward to achieve the folded position of the wheelchair 100. A force is exerted on the scissor frame 204 by pulling two carrying loops 400a, 400b upwards. Optionally, other actuating means may be used to cause movement of the scissor frame 204.

In response to the pulling force, the cross-members 234a, 234b and the pivoting arms 238a, 238b pivot such that the seat supports 240a, 240b separate from their resting position on the support tabs 216a, 216b, 218a, 218b. Specifically, the lower ends of each of the cross-members 234a, 234b pivot about the respective lower longitudinal member 210a, 210b, and the cross-members 234a, 234b pivot about each other at the central pivoting point 236. Similarly, the pivoting arms 238a, 238b pivot at one end relative to the respective upper longitudinal member 212a, 212b and at another end relative to the respective cross-member 234a, 234b. The folding motion generally stops when the pivoting motion of the pivoting arms 238a, 238b is stopped by contact with the respective upper longitudinal members 212a, 212b.

In the folded position, the side frames 202a, 202b are separated by a much smaller distance than in the transporting position. For example, according to one embodiment, the side frames 202a, 202b are separated by a distance of about 500 millimeters (20 inches) in the transporting position and by a distance of about 140 millimeters (5.5 inches) in the folded position.

In alternative embodiments, the wheelchair 100 includes one or more optional features. For example, the wheelchair 100 optionally includes a user seatbelt and/or a cup holder knob coupled to a member of one or more of the side frames 202a, 202b. The user seatbelt can be attached to the lower back area and the cup holder know can be screwed on the upper longitudinal member 212a, 212b.

The wheelchair 100 has been successfully tested to withstand a weight of at least 300 pounds. For example, a fatigue drop test was performed in which the wheelchair 100 was subjected to 6,6667 cycles with a 300 pound weight capacity. During the drop test, the wheelchair 100 was supported in a drop test machine to simulate the wheelchair 100 being supported on a horizontal plane (i.e., having both the front casters 226a, 226b and the rear wheels 228a, 228b on a horizontal plane). The wheelchair 100 was, then, dropped about 50 millimeters (1.97 inches), plus or minus 5 millimeters (0.197 inches), onto a rigid horizontal plane. No failure was found during the test.

Similarly, another fatigue test (referred to as a two-drum test) was performed in which the wheelchair 100 was positioned on two drums that are separated by a distance such that corresponding axles of the casters 226a, 226b and wheels 228a, 228b are directly above respective axles of the drums (within a tolerance of about plus/minus 10 millimeters (0.394 inches). Specifically, the wheelchair 100 was positioned with its driven wheels, e.g., the rear wheels 228a, 228b, on a reference drum and its casters 226a, 226b on the second drum. The wheelchair 100 was constrained longitudinally by devices attached to the axles of the rear wheels 228a, 228b (or, alternatively, by devices attached to the wheelchair 100 as close to the axles of the rear wheels 228a, 228b as possible) such that lateral movement of the wheelchair 10 was limited to plus/minus 50 millimeters (1.97 inches) from a mid-position of the wheelchair 10. The reference drum was operated at a speed of about 1.0 meters/second (plus/minus 0.1 meters/second). The wheelchair 100 was subjected to 200,000 cycles with a 300 pound weight capacity. No failure was found during this test. Further, the wheelchair 100 was approved to meet the requirements prescribed under U.S. Food and Drug Administration (FDA) ISO 7176-8.

While the present invention has been described with reference to one or more particular embodiments, those skilled in the art will recognize that many changes may be made thereto without departing from the spirit and scope of the present invention. For example, instead of attaching the rear wheel 228a to the rear member 208a via a central region of the wheel, the rear wheel 228a may be attached to other members of the wheelchair 100 or to other regions of the wheel using known fastening means. In another example, instead of mounting the brake mechanism 232a to the rear member 228a near and above the outer periphery of the rear wheel 228a, the brake mechanism 232a may be mounted on other members of the wheelchair 100 and may be used to restrain movement of one or more of the front casters 226a, 226b. Each of these embodiments and obvious variations thereof is contemplated as falling within the spirit and scope of the invention, which is set forth in the following claims.

What is claimed is:

1. A manual transport wheelchair for transporting a person and changeable between a transport position and a folded position, the wheelchair having two side frames coupled by a single scissor frame that is movable to change the wheelchair between the transport position and the folded position, the wheelchair having a weight capacity-to-weight ratio of at least nineteen.

2. The wheelchair of claim 1, further comprising a plurality of support tabs coupled to the side frames for supporting a seating area of the wheelchair in the transport position.

3. The wheelchair of claim 2, wherein the support tabs include a front tab and a rear tab, the front tab being located higher than the rear tab.

4. The wheelchair of claim 1, wherein all structural members of the wheelchair, including structural members of the side frames and the scissor frame, are aluminum or aluminum alloys.

5. The wheelchair of claim 1, wherein each of the side frames includes a longitudinal upper member and a longitudinal lower member for coupling a front member and a rear member, the longitudinal upper member being rearwardly angled for minimizing the likelihood of the person falling from the wheelchair when the person is seated in the wheelchair.

6. The wheelchair of claim 1, further comprising a pair of armrests coupled respectively to the side frames, the armrests having a front angled member for providing support to the person when the person is moving between a seating position and a standing position.

7. The wheelchair of claim 1, further comprising:
a rear-lower member coupled to each of the side frames;
a rear-upper member coupled to the rear-lower member via a latching mechanism, the rear-upper member being movable between an upright position and a lowered position; and
a push-grip member coupled at an end of the rear-upper member and positioned generally perpendicular to the rear-upper member, the push-grip member being angled outward with respect to the wheelchair such that the rear-upper member is generally parallel to the rear-lower member in the lowered position.

8. The wheelchair of claim 1, wherein each of the side frames includes a front member and a rear member coupled via a pair of longitudinal members, the longitudinal members including an upper longitudinal member and a lower longitudinal member, the rear member being further coupled to a rear wheel such that an outer wheel periphery is below the lower longitudinal member.

9. The wheelchair of claim 1, wherein the wheelchair has a maximum weight of less than sixteen pounds.

10. A method of manufacturing a manual transport wheelchair, comprising:
coupling a first side frame to a second side frame via a single scissor frame, the scissor frame being movable to change the wheelchair between a transport position and a folded position;
attaching a seating area to the scissor frame, the seating area having a weight capacity of at least three hundred pounds, the wheelchair having a weight of less than sixteen pounds; and
supporting the seating area on a plurality of support tabs when the wheelchair is in the transport position.

11. The method of claim 10, further comprising:
attaching a front member and a rear member of each of the first side frame and the second side frame via a longitudinal upper member and a longitudinal lower member; and
slanting rearwardly the longitudinal upper member for minimizing the likelihood of a person falling from the wheelchair when the person is seated in the wheelchair.

12. The method of claim 10, further comprising:
providing a pair of armrests respectively to the first side frame and the second side frame;
angling a support member of each of the armrests such that a front end of the support member is lower than a rear end of the support member, the support member providing support to a person when the person is moving between a seating position and a standing position.

13. The method of claim 10, further comprising:
providing a rear-lower member to each of the first side frame and the second side frame;
coupling a rear-upper member to each of the respective rear-lower members via latching mechanisms, each of the rear-upper members being movable between a standard position and a lowered position;
attaching a push-grip member at an upper end of each of the rear-upper members; and
angling the push-grip members outwardly with respect to the wheelchair such that the rear-upper members are generally parallel to the rear-lower members when in the lowered position.

14. The method of claim 10, further comprising:
providing a front tubular member and a rear tubular member to each of the first side frame and the second side frame, the front tubular member and the rear tubular member being coupled via an upper longitudinal tubular member and a lower longitudinal tubular member; and
coupling a rear wheel to an end of the rear tubular member, the end of the rear tubular member being below an intersection between the rear tubular member and the lower longitudinal tubular member.

15. The method of claim 14, wherein the rear wheel has an outer periphery that is located below the lower longitudinal tubular member.

16. A transport wheelchair being movable between a transport position for transporting a person and a folded position for storing the wheelchair, comprising:
a seating area for supporting the person in the seated position;
a pair of side frames having respective front members and rear members, the front members being respectively coupled to the rear members via longitudinal upper members and longitudinal lower members;
a plurality of support tabs attached to the longitudinal upper members for supporting the seating area when the wheelchair is in the seated position;
a single centrally located scissor frame for coupling the pair of side frames, the scissor frame being movable to change the wheelchair between the seated position and the folded position, the wheelchair having a maximum weight of less than sixteen pounds.

17. The wheelchair of claim 16, wherein all structural members of the side frames and the scissor frame are aluminum or aluminum alloys.

18. The wheelchair of claim 16, further comprising a plurality of structural reinforcements, the structural reinforcements being located near one or more intersections between the front members and the longitudinal upper members, between the front members and the longitudinal lower members, between the rear members and the longitudinal upper members, between the rear members and the longitudinal lower members, and between the scissor frame and the side frames.

19. The wheelchair of claim 18, wherein the structural reinforcements include one or more welding spots or tubular members.

20. The wheelchair of claim 19, wherein at least one of the tubular members is located within one of the longitudinal lower members or the rear members.
